(19) United States
(12) Patent Application Publication
(10) Pub. No.: US 2023/0120658 A1
(43) Pub. Date: Apr. 20, 2023

(54) INTER-OPERATOR BACKPROPAGATION IN AUTOML FRAMEWORKS

(71) Applicant: International Business Machines Corporation, Armonk, NY (US)

(72) Inventors: Kiran A. Kate, Chappaqua, NY (US); Sairam Gurajada, San Jose, CA (US); Tejaswini Pedapati, White Plains, NY (US); Martin Hirzel, Chappaqua, NY (US); Lucian Popa, San Jose, CA (US); Yunyao Li, San Jose, CA (US); Jason Tsay, White Plains, NY (US)

(21) Appl. No.: 17/506,395

(22) Filed: Oct. 20, 2021

(51) Int. Cl. G06N 3/08

(52) U.S. Cl. CPC G06N 3/084

(57) ABSTRACT

Systems, computer-implemented methods, and computer program products to facilitate inter-operator backpropagation in AutoML frameworks are provided. According to an embodiment, a system can comprise a processor that executes computer executable components stored in memory. The computer executable components comprise a selection component that selects a subset of deep learning and non-deep learning operators. The computer executable components further comprise a training component which trains the subset of deep learning and non-deep learning operators, wherein deep learning operators in the subset of deep learning and non-deep learning operators are trained using backpropagation across at least two deep learning operators of the subset of deep learning and non-deep learning operators.

### BACKGROUND

The subject disclosure relates to automated machine learning (AutoML), and more specifically, to inter-operator backpropagation in AutoML frameworks.

Use of automated machine learning has great potential to address a variety of problems. For example, AutoML offers solutions with better predictive performance when compared to non-automated machine learning. Currently, there exist two dominant techniques for machine learning. One is based on neural networks, referred to as deep learning (DL), and the other is based on traditional machine learning approaches such as decision trees, and support vector machines referred to as non-deep learning (non-DL).

However, a problem with existing AutoML frameworks is that they use independent optimizers to guide the search between different techniques, such as deep learning and non-deep learning. In many machine learning applications however, the space of possible machine learning models is not strictly either deep learning or non-deep learning. For some applications, both deep learning and non-deep learning could be applicable, and the search space can be driven by predictive performance, as well as constraints on runtime and resource availability. As such, in a single model or operator pipeline there could be some components which are non-deep learning and some that are deep learning. Existing AutoML frameworks unsuitable for use in problems that combine non-deep learning with deep learning due to their use of independent optimizers.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate inter-operator backpropagation in AutoML frameworks are described.

According to an embodiment, a system can comprise a processor that executes computer executable components stored in memory. The computer executable components comprise a selection component that selects a subset of deep learning and non-deep learning operators. The computer executable components further comprise a training component which trains the subset of deep learning and non-deep learning operators, wherein deep learning operators in the subset of deep learning and non-deep learning operators are trained using backpropagation across at least two deep learning operators of the subset of deep learning and non-deep learning operators. An advantage of such a system is that it can handle both deep learning operators and non-deep learning operators in an AutoML framework.

In some embodiments of the above described system, the backpropagation comprises passing of gradients computed from a loss backwards to adjust learned coefficients in the subset of deep learning and non-deep learning operators. An advantage of such a system is that it allows for accurate training of deep learning operators in the subset of deep learning and non-deep learning operators.

According to another embodiment, a computer-implemented method can comprise selecting, by a system operatively coupled to a processor, a subset of deep learning and non-deep learning operators. The computer-implemented system can further comprise training, by the system, the subset of deep learning and non-deep learning operators, wherein deep learning operators in the subset of deep learning and non-deep learning operators are trained using backpropagation across at least two deep learning operators of the subset of deep learning and non-deep learning operators. An advantage of such a computer-implemented method is that it can handle both deep learning operators and non-deep learning operators in an AutoML framework.

In some embodiments of the above described computer-implemented method, the backpropagation comprises passing of gradients computed from a loss backwards to adjust learned coefficients in the set of deep learning and non-deep learning operators. An advantage of such a computer-implemented method is that it allows for accurate training of deep learning operators in the subset of deep learning and non-deep learning operators.

According to another embodiment, a computer program product comprising a computer readable storage medium having program instructions embodied therewith, the program instructions executable by a processor to cause the processor to select a subset of deep learning operators and non-deep learning operators. The program instructions are further executable by the processor to cause the processor to train the subset of deep learning and non-deep learning operators, wherein deep learning operators in the subset of deep learning and non-deep learning operators are trained using backpropagation across at least two deep learning operators of the subset of deep learning and non-deep learning operators. An advantage of such a computer program product is that it can handle both deep learning operators and non-deep learning operators in an AutoML framework.

In some embodiments of the above described computer program product, the backpropagation comprises passing of gradients computed from a loss backwards to adjust learned coefficients in the set of deep learning and non-deep learning operators. An advantage of such a computer program product is that it allows for accurate training of deep learning operators in the subset of deep learning and non-deep learning operators.

### DESCRIPTION OF THE DRAWINGS

FIG. 1 illustrates a block diagram of an example, non-limiting system that can facilitate inter-operator backpropagation in AutoML frameworks in accordance with one or more embodiments described herein.

FIG. 2 illustrates an example, non-limiting diagram that can facilitate inter-operator backpropagation in AutoML frameworks in accordance with one or more embodiments described herein.

FIG. 3 illustrates an example, non-limiting diagram representation of a subset of deep learning and non-deep learning operators in accordance with one or more embodiments described herein.

FIG. 4 illustrates an example, non-limiting diagram that can facilitate a forward pass as part of backpropagation across two or more deep learning operators in accordance with one or more embodiments described herein.

FIG. 5 illustrates an example, non-limiting diagram that can facilitate a backwards pass and gradient update as part of backpropagation across two or more deep learning operators in accordance with one or more embodiments described herein.

FIG. 6 illustrates an example, non-limiting diagram that can facilitate backpropagation across deep learning operators in accordance with one or more embodiments described herein.

FIG. 7 illustrates an example, non-limiting diagram that can facilitate marking of deep learning operators by a higher order operator in accordance with one or more embodiments described herein.

FIG. 8 illustrates a flow diagram of an example, non-limiting computer-implemented method that can facilitate inter-operator backpropagation in AutoML frameworks in accordance with one or more embodiments described herein.

FIG. 9 illustrates a flow diagram of an example, non-limiting computer-implemented method that can facilitate inter-operator backpropagation in AutoML frameworks in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given problems described above with existing AutoML frameworks, the present disclosure can be implemented to produce a solution to these problems in the form of systems, computer-implemented methods, and/or computer program products that can facilitate inter-operator backpropagation in AutoML framework by: selecting a subset of deep learning operators and non-deep learning operators; and/or training the subset of deep learning and non-deep learning operators, wherein deep learning operators in the subset of deep learning and non-deep learning operators are trained using backpropagation across at least two deep learning operators of the subset of deep learning and non-deep learning operators. An advantage of such systems, computer-implemented methods, and computer program products is that they can handle both deep learning operators and non-deep learning operators in an AutoML framework.

In some embodiments, the present disclosure can be implemented to produce a solution to the problems described above in the form of systems, computer-implemented methods, and/or computer program products that can further facilitate inter-operator backpropagation in AutoML frameworks by: training the subset of deep learning and non-deep learning operators, wherein deep learning operators in the subset of deep learning and non-deep learning operators are trained using backpropagation across at least two deep learning operators of the subset of deep learning and non-deep learning operators, wherein the backpropagation comprises passing of gradients computed from a loss backwards to adjust learned coefficients in the set of deep learning and non-deep learning operators. An advantage of such systems, computer-implemented methods, and/or computer program products is that they can be implemented to accurately train deep learning operators in the subset of deep learning and non-deep learning operators.

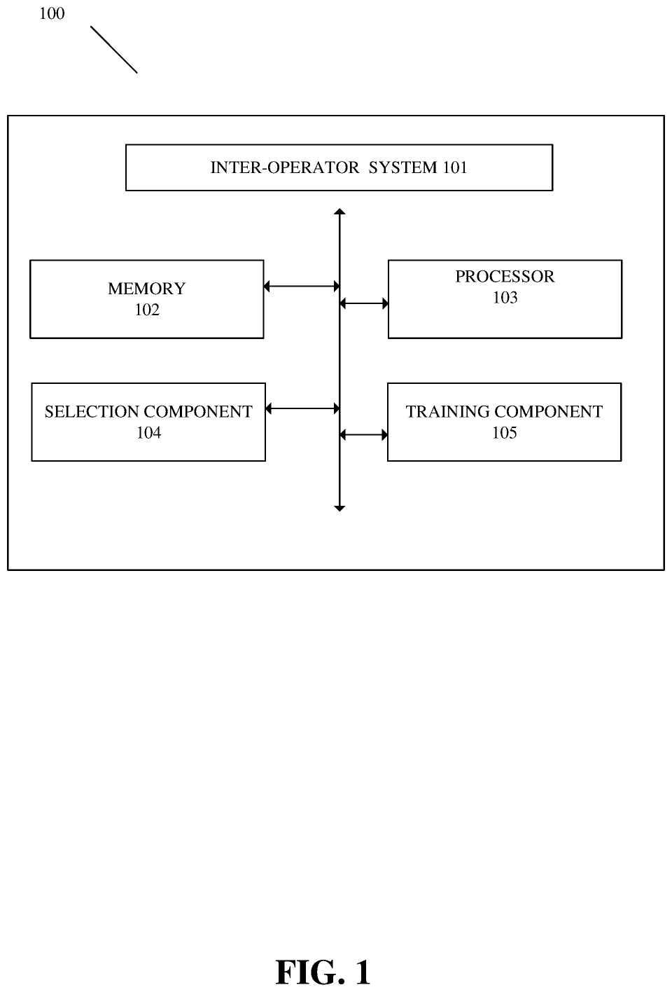

FIG. 1 illustrates block diagrams of example, non-limiting system 100 that can facilitate inter-operator backpropagation in AutoML frameworks. System 100 can comprise inter-operator system 101. Inter-operator system 101 of system 100 can comprise a memory 102, a processor 103, a selection component 104, and a training component 105.

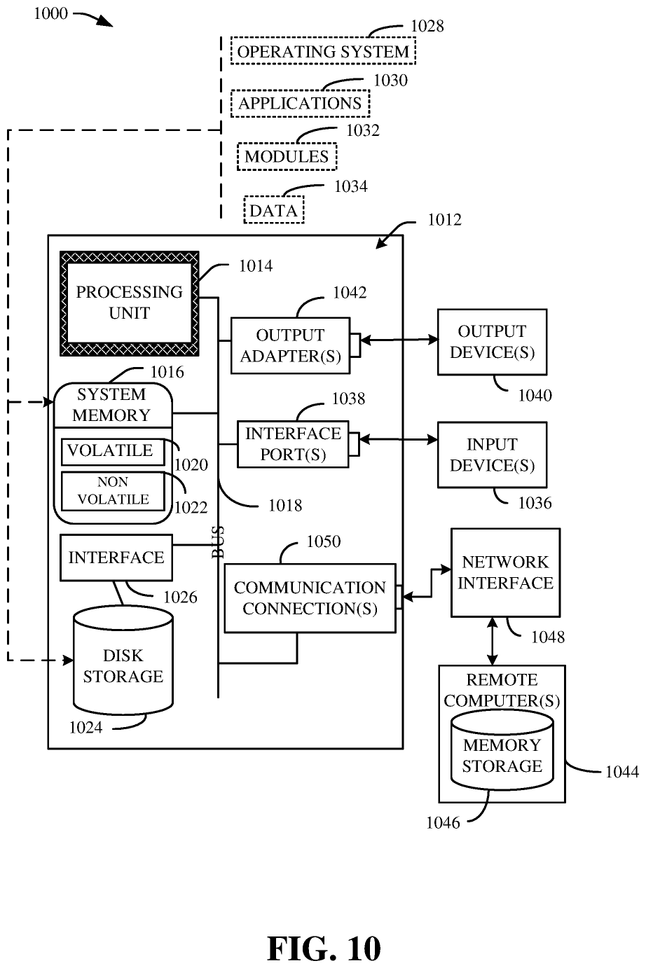

It should be appreciated that the embodiments of the subject disclosure depicted in various figures disclosed herein are for illustration only, and as such, the architecture of such embodiments are not limited to the systems, devices, and/or components depicted therein. For example, in some embodiments, system 100 and/or inter-operator system 101 can further comprise various computer and/or computing-based elements described herein with reference to operating environment 1000 and FIG. 10. In several embodiments, such computer and/or computing-based elements can be used in connection with implementing one or more of the systems, devices, components, and/or computer-implemented operations shown and described in connection with FIG. 1 and/or other figures disclosed herein.

Memory 102 can store one or more computer and/or machine readable, writable, and/or executable components and/or instructions that, when executed by processor 103 (e.g., a classical processor, a quantum processor, and/or another type of processor), can facilitate performance of operations defined by the executable component(s) and/or instruction(s). For example, memory 102 can store computer and/or machine readable, writable, and/or executable components and/or instructions that, when executed by processor 103, can facilitate execution of the various functions described herein relating to inter-operator system 101, selection component 14, training component 105, and/or another component associated with inter-operator system 101.

Memory 102 can comprise volatile memory (e.g., random access memory (RAM), static RAM (SRAM), dynamic RAM (DRAM), and/or another type of volatile memory) and/or non-volatile memory (e.g., read only memory (ROM), programmable ROM (PROM), electrically programmable ROM (EPROM), electrically erasable programmable ROM (EEPROM), and/or another type of non-volatile memory) that can employ one or more memory architectures. Further examples of memory 102 are described below with reference to system memory 1016 and FIG. 10. Such examples of memory 102 can be employed to implement any embodiments of the subject disclosure.

Processor 103 can comprise one or more types of processors and/or electronic circuitry (e.g., a classical processor, a quantum processor, and/or another type of processor and/or electronic circuitry) that can implement one or more computer and/or machine readable, writable, and/or executable components and/or instructions that can be stored on memory 102. For example, processor 103 can perform various operations that can be specified by such computer and/or machine readable, writable, and/or executable components and/or instructions including, but not limited to, logic, control, input/output (I/O), arithmetic, and/or the like. In some embodiments, processor 103 can comprise one or more central processing unit, multi-core processor, microprocessor, dual microprocessors, microcontroller, System on a Chip (SOC), array processor, vector processor, quantum processor, and/or another type of processor. Further examples of processor 103 are described below with reference to processing unit 1014 and FIG. 10. Such examples of processor 103 can be employed to implement any embodiments of the subject disclosure.

Inter-operator system 101, memory 102, processor 103, selection component 104, training component 105, and/or another component of inter-operator system 101 as described herein can be communicatively, electrically, operatively, and/or optically coupled to one another via bus 106 to perform functions of system 100, inter-operator system 101, and/or any components coupled therewith. Bus 106 can comprise one or more memory bus, memory controller, peripheral bus, external bus, local bus, a quantum bus, and/or another type of bus that can employ various bus architectures. Further examples of bus 106 are described below with reference to system bus 1018 and FIG. 10. Such examples of bus 106 can be employed to implement any embodiments of the subject disclosure.

Inter-operator system 101 can comprise any type of component, machine, device, facility, apparatus, and/or instrument that comprises a processor and/or can be capable of effective and/or operative communication with a wired and/or wireless network. All such embodiments are envisioned. For example, inter-operator system 101 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

Inter-operator system 101 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) using a wire and/or a cable. For example, inter-operator system 101 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) using a data cable including, but not limited to, a High-Definition Multimedia Interface (HDMI) cable, a recommended standard (RS) 232 cable, an Ethernet cable, and/or another data cable.

In some embodiments, inter-operator system 101 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) via a network. For example, such a network can comprise wired and/or wireless networks, including, but not limited to, a cellular network, a wide area network (WAN) (e.g., the Internet) or a local area network (LAN). Inter-operator system 101 can communicate with one or more external systems, sources, and/or devices, for instance, computing devices using virtually any desired wired and/or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. Therefore, in some embodiments, inter-operator system 101 can comprise hardware (e.g., a central processing unit (CPU), a transceiver, a decoder, quantum hardware, a quantum processor, and/or other hardware), software (e.g., a set of threads, a set of processes, software in execution, quantum pulse schedule, quantum circuit, quantum gates, and/or other software) or a combination of hardware and software that can facilitate communicating information between inter-operator system 101 and external systems, sources, and/or devices (e.g., computing devices, communication devices, and/or another type of external system, source, and/or device).

Inter-operator system 101 can comprise one or more computer and/or machine readable, writable, and/or executable components and/or instructions that, when executed by processor 103 (e.g., a classical processor, a quantum processor, and/or another type of processor), can facilitate performance of operations defined by such component(s) and/or instruction(s). Further, in numerous embodiments, any component associated with inter-operator system 101, as described herein with or without reference to the various figures of the subject disclosure, can comprise one or more computer and/or machine readable, writable, and/or executable components and/or instructions that, when executed by processor 103, can facilitate performance of operations defined by such component(s) and/or instruction(s). For example, selection component 104, training component 105, and/or any other components associated with inter-operator system 101 as disclosed herein (e.g., communicatively, electronically, operatively, and/or optically coupled with and/or employed by inter-operator system 101), can comprise such computer and/or machine readable, writable, and/or executable component(s) and/or instruction(s). Consequently, according to numerous embodiments, inter-operator system 101 and/or any components associated therewith as disclosed herein, can employ processor 103 to execute such computer and/or machine readable, writable, and/or executable component(s) and/or instruction(s) to facilitate performance of one or more operations described herein with reference to inter-operator system 101 and/or any such components associated therewith.

Inter-operator system 101 can facilitate (e.g., via processor 103) performance of operations executed by and/or associated with selection component 104, training component 105, and/or another component associated with inter-operator system 101 as disclosed herein. For example, as described in detail below, inter-operator system 101 can facilitate (e.g., via processor 103): selecting a subset of deep learning and non-deep learning operators; and/or training the subset of deep learning and non-deep learning operators, wherein deep learning operators in the subset of deep learning and non-deep learning operators are trained using backpropagation across at least two deep learning operators of the subset of deep learning and non-deep learning operators. In another example, as described in detail below, inter-operator system 101 can further facilitate (e.g., via processor 103): training deep learning operators in the subset of deep learning and non-deep learning operators using backpropagation across at least two deep learning operators of the subset of deep learning and non-deep learning operators, wherein the backpropagation comprises passing of gradients computed from a loss backwards to adjust learned coefficients in the subset of deep learning and non-deep learning operators.

Selection component 104 can select a subset of deep learning and non-deep learning operators. In an example, selection component 104 can receive a search space of machine learning operators comprising deep learning and non-deep learning operators, wherein the deep learning and non-deep learning operators have connections between each other. In this embodiment, selection component 104 can choose a first operator from the search space and then select a subset of deep learning and non-deep learning operators by including all operators which have connection to the first operator. In another embodiment, the search space of machine learning operators can comprise a directed acyclic graph of deep learning and non-deep learning operators, which selection component 104 can select a subset of deep learning and non-deep learning operators from. In this example, selection component 104 can select a first operator by selecting an operator that does not have an edge leading to it. Selection component 104 can then select the subset of deep learning and non-deep learning operators by following an edge from the first operator to a next operator, including the next operator in the subset, and following an edge from the next operator. This process can continue until selection component 104 reaches an operator which has no edge leading away from it, at which point selection of the subset of deep learning and non-deep learning operators is complete.

In another embodiment, the search space can comprise scikit-learn style pipelines comprising one or more choices, wherein the one or more choices comprise one or more deep learning and/or non-deep learning operators. In this embodiment, selection component 104 can select a subset of deep learning and non-deep learning operators by choosing a scikit-learn style pipeline from the search space. In an embodiment, selection component 104 can select a pipeline at random, or in another embodiment, selection component 104 can select a pipeline based on an order of the pipelines contained in the search space. In a scikit-learn style pipeline, deep learning operators can behave like transformers, first or intermediate operators in a pipeline, or like estimators, final operators in a pipeline. Transformers can support a transform method, whereas estimators can support regression or classification with class probabilities via a predict_proba method. In neural networks, first or intermediate layers of the network can be represented as deep learning featurizer operators and final layers of the network can be represented as deep learning head operators. As such, when a neural network is represented in a scikit-learn style pipeline as multiple operators, deep learning featurizers can be represented as scikit-learn style transformers with a transform method such as a BERT embedding, or a feature extraction layers of an image classifier. As deep learning heads are the final layers in a neural network, they can be represented as scikit-learn style estimators with a predict_proba method, such as the final layers of the ResNet50 architecture.

In an embodiment, selection component 104 can select a subset of deep learning and non-deep learning operators, wherein the subset of deep learning and non-deep learning operators is a specific instantiation of deep learning and non-deep learning operators and hyperparameters, wherein the hyperparameters are tuned automatically. For example, selection component 104 can select a subset as described above, and if an operator in the subset of deep learning and non-deep learning operators requires a hyperparameter, selection component 104 can include a value for the hyperparameter in the subset of deep learning and non-deep learning operators. In an embodiment, selection component 104 can select a value for the hyperparameter from a pre-generated list of hyperparameter values. In another embodiment, selection component 104 can tune hyperparameters utilizing Bayesian optimization or Gradient-Decent optimization. For example, if the subset of deep learning and non-deep learning operators includes a random forest classifier, selection component 104 can include a hyperparameter representing the number of trees in the random forest in the subset and a value for the hyperparameter. Selection component 104 can tune, or select a value for, one or more hyperparameters included in the subset of deep learning and non-deep learning operators.

It should be appreciated that this approach allows for a single neural network to be represented by multiple deep learning operators in a scikit-learn style pipeline. Doing so means that no separate class is used for each combination of deep learning layers as opposed to the existing approach of wrapping an entire neural network as a single monolithic scikit-learn style operator. This makes it possible to pre-train coefficients of a deep learning transformer and then reuse it in a different pipeline or subset of operators. This reuse is flexible, for instance, by working both with and without fine-tuning. This multi-operator approach enables existing AutoML tools to work with pipelines or subsets comprising both deep learning and non-deep learning pipelines. Specifically, it makes it possible for AutoML to select deep learning or non-deep learning operators and tune their hyperparameters at a finer granularity as hyperparameters for each layer of a neural network can be tuned independently.

In one or more of the above examples, deep learning operators in the subset of deep learning and non-deep learning operators can be implemented in the same deep learning frameworks or one or more different deep learning frameworks. For example, if the subset of deep learning and non-deep learning operators comprises a first deep learning operator and a second deep learning operator, the first and second deep learning operators can be implemented in the same deep learning framework. In another example, the first deep learning operator can be implemented in a first deep learning framework and the second deep learning operator can be implemented in a second deep learning framework. It should be appreciated that this allows for greater flexibility in selection of subsets of operators.

In one or more of the above examples, deep learning operators in the subset of deep learning and non-deep learning operators can be marked by a higher order, or meta-order, operator. A higher order operator can be defined as an operator that takes other operators as input. For example, if the subset of deep learning and non-deep learning operators comprises a first non-deep learning operator, a first deep learning operator, and a second deep learning operator, the first and second deep learning operators can be marked by, or contained within, a higher order operator that takes the first and second deep learning operators as input and the first non-deep learning operator can be left unmarked by a higher order operator. It should be appreciated that by marking deep learning operators with higher order operators, inter-operator system 101, selection component 104, training component 105, and/or any other components associated therewith can identify an operator as either a deep learning or non-deep learning operator based on the presence or absence of a higher order operator. Additionally, it should be appreciated that selection component 104 can repeat the selection process multiple times. For example, selection component 104 can repeatedly select new subsets of operators or pipelines from a search space until all subsets of operators or pipelines have been selected.

Training component 105 can train the deep learning and non-deep learning operators in the subset of deep learning and non-deep learning operators. In an embodiment, non-deep learning operators can be trained using existing scikit-learn techniques for non-deep learning operators. In another embodiment, deep learning operators can be trained using backpropagation across at least two deep learning operators of the subset of deep learning and non-deep learning operators. For example, the backpropagation can comprise passing of gradients (first order derivatives) from a loss backwards to adjust coefficients in the subset of deep learning and non-deep learning operators. In this example, training component 105 can train two or more deep learning operators using backpropagation by repeatedly executing three phases: a forward pass, a backwards pass, and updating learned coefficients using a stochastic gradient decent (SGD) optimizer. For example, given a deep learning featurizer and a deep learning head, training component 105 can execute a forward pass by executing the featurizer's transform method on an input x and the featurizer's learned coefficients θ_{F} to compute transformed features h. Training component 105 can continue the forward pass by executing the head's predict_prob method using h and the head's learned coefficients θ_{H} to compute ŷ. Training component 105 can complete the forward pass by executing a loss function which uses ŷ and ground-truth labels y to compute a loss L.

Training component 105 can execute a backwards pass by computing loss', the derivative of the loss function. Training component 105 can continue the backwards pass by computing

$$\frac{\partial L}{\partial \hat{y}} ,$$

which is the gradient of the loss with respect to ŷ, and executing the head's backwards method using h,

$$\frac{\partial L}{\partial \hat{y}} ,$$

and θ_{H} to compute two gradients. These two gradients are

$$\frac{\partial L}{\partial {θ}_{H}} ,$$

the gradient of the loss with respect to θ_{H}, and

$$\frac{\partial L}{\partial h} ,$$

the gradient of the loss with respect to h. Training component 105 can complete the backwards pass by executing the featurizer's backward method, which uses x,

$$\frac{\partial L}{\partial h} ,$$

and θ_{F} to compute two gradients. These two gradients are

$$\frac{\partial L}{\partial {θ}_{F}} ,$$

the gradient of the loss with respect to θ_{F}, and

$$\frac{\partial L}{\partial x} ,$$

the gradient of the loss with respect to x.

In an embodiment, training component 105 can include an optimizer to optimize the training process. For example, training component 105 can use the gradient of the loss with respect to the learned coefficients of the operators in the direction of the descending loss. More specifically, an SGD optimizer can use

$$\frac{\partial L}{\partial {θ}_{H}}$$

to update θ_{H} and

$$\frac{\partial L}{\partial {θ}_{F}}$$

to update θ_{F}. It should be appreciated that this entire process of forward pass, backwards pass, and optimization can be repeated multiple times during training. In an embodiment, the training process can repeat a set number of times. In another embodiment, the training process can repeat for a number of times determined based on resource usage. In a further embodiment, the training process can be repeated until the accuracy of the training is within a threshold of an intended accuracy.

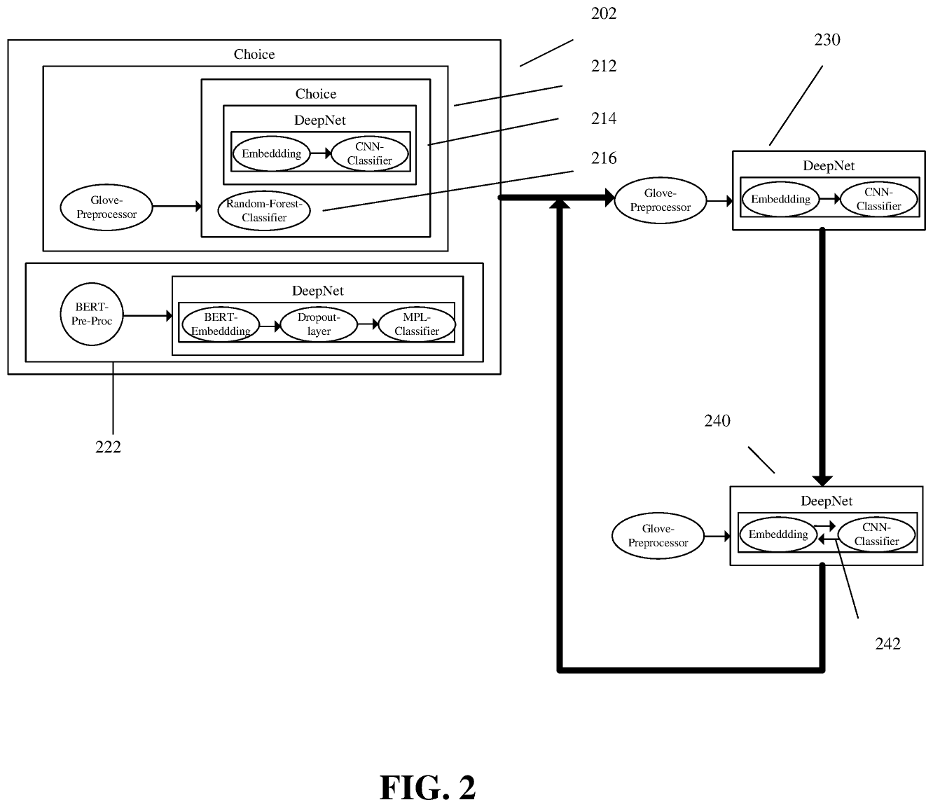

FIG. 2 illustrates an example, non-limiting diagram that can facilitate inter-operator backpropagation in AutoML frameworks in accordance with one or more embodiments described herein. Repetitive description of like elements and/or processes employed in respective embodiments is omitted for sake of brevity.

Diagram 200 comprises an AutoML search space 202 comprising a set of possible models, in this case represented as scikit-learn style pipelines which inter-operator system 101 can receive as input. The possible models in search space 202 can differ from one and other in their hyperparameters and values of their hyperparameters. Here, search space 202 comprises a first choice 212 which comprises the operator Glove-Preprocessor, a first branch 214, and a second branch 216. The first branch 214 comprises deep learning operators Embedding and CNN-Classifier, denoted as deep learning operators by the presence of a higher order operator, DeepNet. The first branch 214 has two neural network layers represented by the two deep learning operators. The second branch 216 comprises the non-deep learning operator Random-Forest-Classifier, denoted as a non-deep learning operator by the absence of a higher order operator. Search space 202 additionally comprises a second choice 222, which comprises the non-deep learning operator BERT-Pre-Proc, followed by the deep learning operators BERT-Embedding, Dropout-layer, and MPL-Classifier, denoted by the presence of the higher order operator DeepNet. The second choice 222 has three neural network layers represented by the three deep learning operators.

As described above with reference to FIG. 1, at 230, selection component 104 can select the first branch 214 of the first choice 212 as a subset, or pipeline, of machine learning operators as well as exact hyperparameters and hyperparameter values for the operators in the subset of machine learning operators.

As described above with reference to FIG. 1, at 240, training component 105 can train the operators within the selected subset of machine learning operators. As the subset comprises the first branch 214, training component 105 can train the operators Glove-Preprocessor, Embedding, and CNN-Classifier. As Glove-Preprocessor is a non-deep learning step, in this case, training component 105 can determine a value based on a look up table. Training component 105 can pass the transformed output of Glove-Preprocessor to the training of the rest of the subset. The rest of the subset, first branch 214, comprises the deep learning operators Embedding and CNN-Classifier. Training component 105 can train Embedding and CNN-Classifier together using backpropagation of gradients through forward and backwards passes 242. As described above in reference to FIG. 1, at 260, training component 105 can pass the gradients to an optimizer used for AutoML. As AutoML is an iterative process, selection component 104 can then select a new subset of operators and training component 105 can train the new subset of operators. Inter-operator system 101 can iterate through this process for all the possible subsets, or pipelines, within the search space 202. For example, inter-operator system 101 can iterate through the selection, and training of the second branch 216 of the first choice 212 and/or the second choice 222.

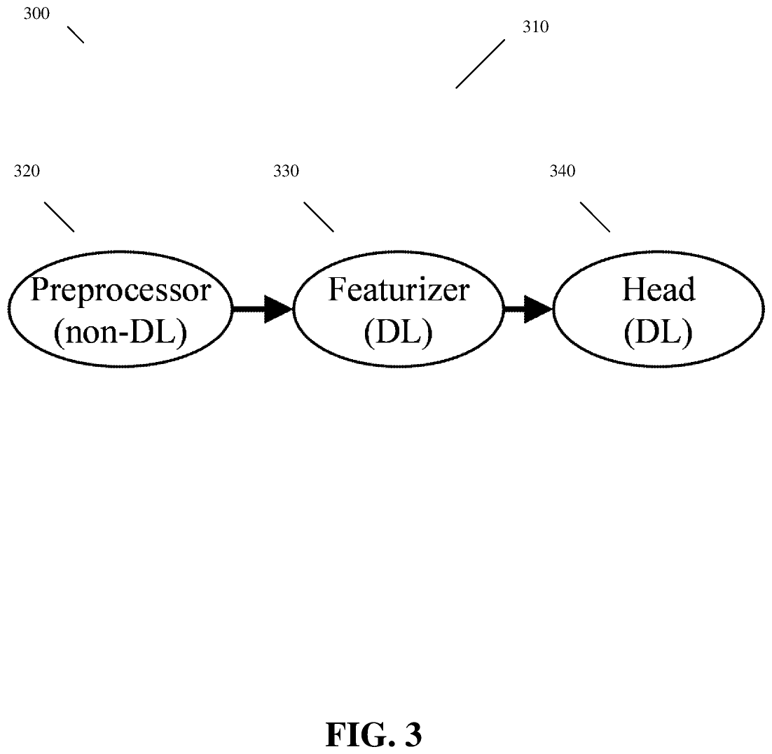

FIG. 3 illustrates an example, non-limiting diagram representation of a subset of deep learning and non-deep learning operators in accordance with one or more embodiments described herein. Repetitive description of like elements and/or processes employed in respective embodiments is omitted for sake of brevity.

Diagram 300 comprises an example subset of deep learning and non-deep learning operators 310 in a scikit-learn style pipeline. As discussed above with reference to FIG. 1, scikit-learn style pipelines can comprise transformers and estimators. As such, deep learning operators in the subset of deep learning and non-deep learning operators can behave like transformers or estimators, with featurizers, intermediate or first operators in the pipeline, being represented as transformers with a transform method and heads, final operators in the pipeline being represented as estimators with a predict_prob method. Example subset of deep learning and non-deep learning operators 310 can comprise a preprocessor 320 non-deep learning operator, a featurizer deep learning operator 330, and a head deep learning operator 340. As noted above with reference to FIG. 1, featurizer 330 and head 340 can represent layers in a neural network as opposed to using a single monolithic operator.

It should be appreciated that by representing a neural network as multiple deep learning operators, no separate class is used for each combination of deep learning layers as in existing AutoML frameworks. This makes it possible to pre-train coefficients of a deep learning operator and then reuse the trained operator in a different pipeline or subset. Additionally, this reuse can be flexible, working both with or without fine-tuning.

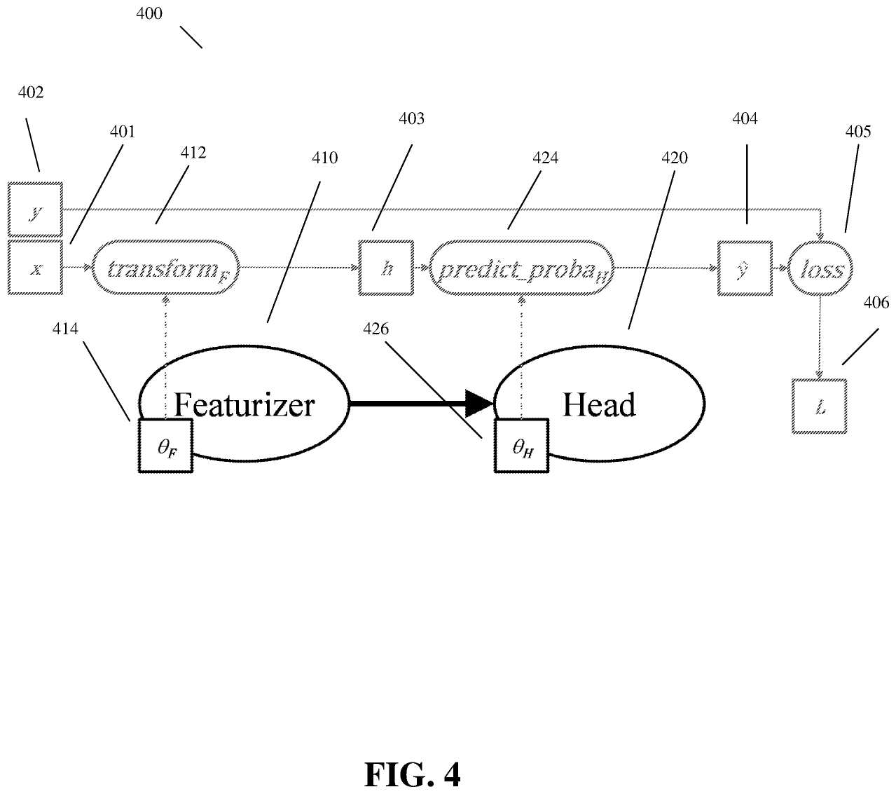

FIG. 4 illustrates an example, non-limiting diagram that can facilitate a forward pass as part of backpropagation across two or more deep learning operators in accordance with one or more embodiments described herein. Repetitive description of like elements and/or processes employed in respective embodiments is omitted for sake of brevity.

Diagram 400 comprises a deep learning featurizer operator 410 and a deep learning head operator 420. As described above in reference to FIG. 1, training component 105 can begin a forward pass by executing transform method 412, which uses as input parameter x 401, and the featurizer's learned coefficient θ_{F} 414 to compute transformed features h 403. Training component 105 can continue the forward pass by executing predict_prob method 424, which takes as input transformed features h 403 and the head's learned coefficient θ_{H} 426 to compute ŷ 404. Training component 105 can complete the forward pass by executing a loss function 405, which takes as input ŷ 404 and ground-truth labels y 402 to compute a loss L 406.

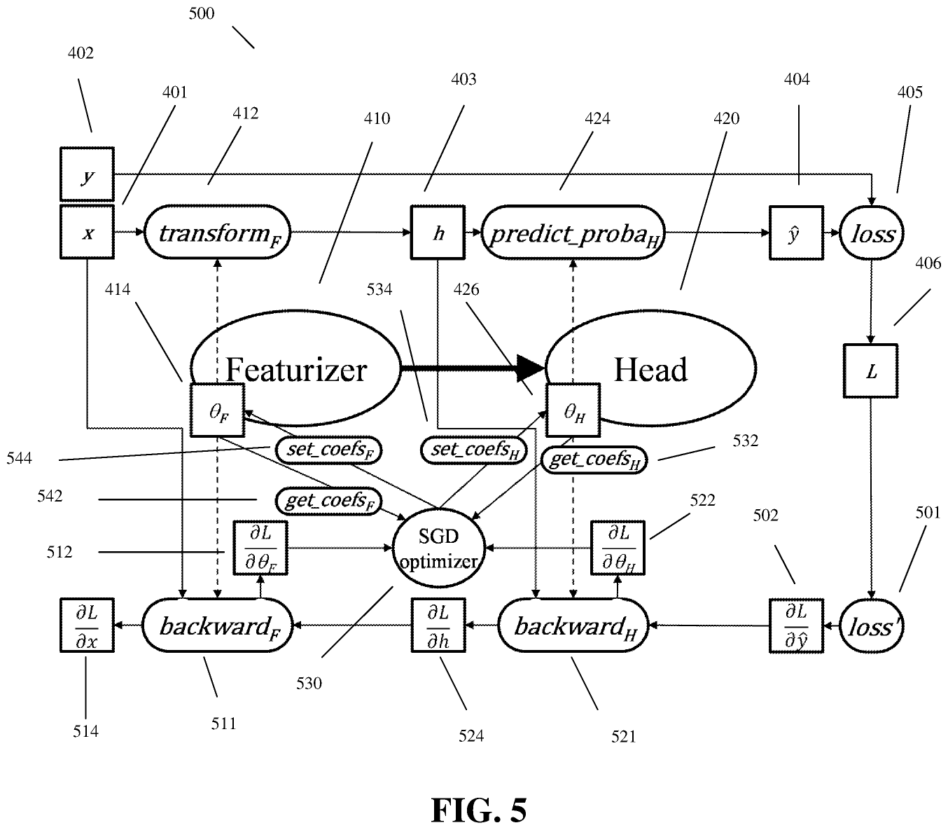

FIG. 5 illustrates an example, non-limiting diagram that can facilitate a backwards pass and a gradient update as part of backpropagation across two or more deep learning operators in accordance with one or more embodiments described herein. Repetitive description of like elements and/or processes employed in respective embodiments is omitted for sake of brevity.

Diagram 500 comprises deep learning featurizer operator 410 and deep learning head operator 420. As described above in reference to FIG. 1, training component 105 can begin a backwards pass by using loss' 501, the derivative of loss L 406, to compute

$$\frac{\partial L}{\partial \hat{y}}$$

502, which is the gradient of the loss with respect to ŷ 404. Training component 105 can continue the backwards pass by executing backwards method 521, which uses as input transformed features h 403, gradient

$$\frac{\partial L}{\partial \hat{y}}$$

502, and learned coefficient θ_{H} 426 to compute two gradients. The two gradients are

$$\frac{\partial L}{\partial {θ}_{H}}$$

522, the gradient of the loss with respect to learned coefficient θ_{H} 424 and

$$\frac{\partial L}{\partial h}$$

524, the gradient of the loss with respect to transformed features h 403. Training component 105 can complete the backwards pass by executing backward method 511, which takes as input

$$\frac{\partial L}{\partial h}$$

524, learned coefficient θ_{F} 414, and input parameter x 401, and computes two gradients. The two gradients are

$$\frac{\partial L}{\partial {θ}_{F}}$$

512, the gradient of the loss with respect to learned coefficient θ_{F} 414, and

$$\frac{\partial L}{\partial x}$$

514, the gradient of the loss with respect to x 401.

As described above in reference to FIG. 1, training component 105 can optimize the training process through the use of an SGD optimizer 530. SGD optimizer 530 can use method get_coefs 532 to get learned coefficient θ_{H} 424, optimize learned coefficient θ_{H} 424 based on gradient

$$\frac{\partial L}{\partial {θ}_{H}}$$

522, and use set_coefs method 534 to set the new value of θ_{H} 424, Similarly, SGD optimizer 530 can use method get_coefs 542 to get learned coefficient θ_{F} 414, optimize θ_{F} 414 based on gradient

$$\frac{\partial L}{\partial {θ}_{F}}$$

512, and use set_coefs method 544 to set the new value of θ_{F} 414.

As described above in reference to FIG. 1, the process of forward pass, backwards pass, and gradient update can be repeated multiple times during the training process. For example, training component 105 can repeat the process of forward pass, backwards pass, and gradient update for Featurizer 410 and Head 420 multiple times. Additionally, it should be appreciated that while FIG. 5 comprises backpropagation across only two deep learning operators, additional deep learning operators can be chained together to allow backpropagation across additional deep learning operators.

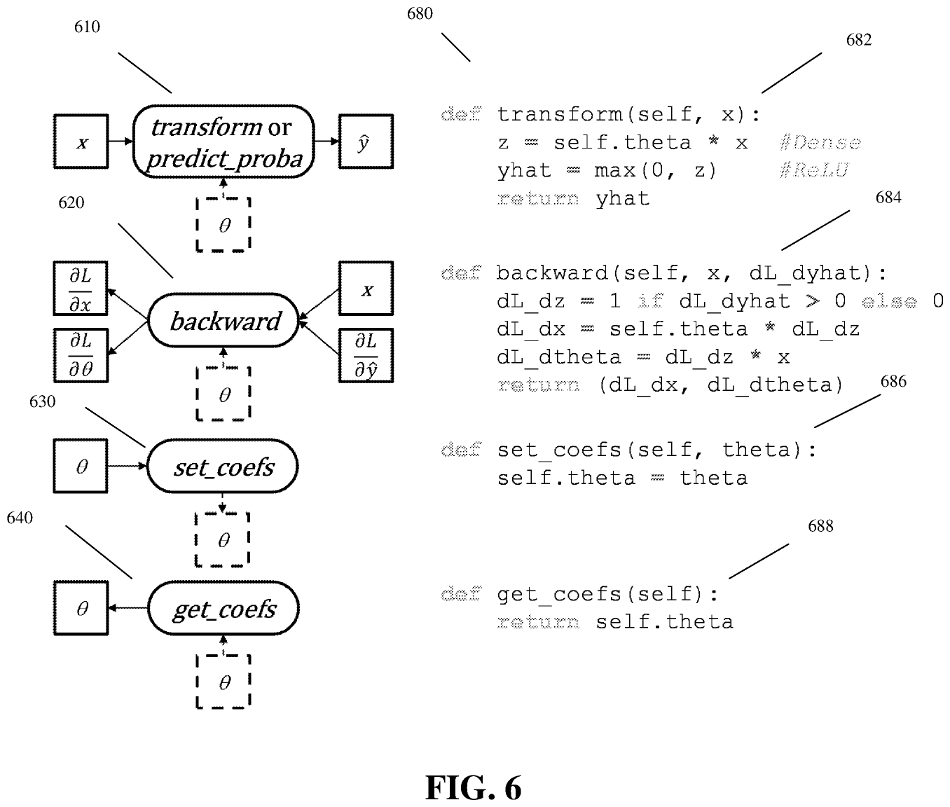

FIG. 6 illustrates an example, non-limiting diagram that can facilitate backpropagation across deep learning operators in accordance with one or more embodiments described herein. Repetitive description of like elements and/or processes employed in respective embodiments is omitted for sake of brevity.

Diagram 600 comprises methods transform or predict_proba 610, backward 620, set_coefs 630, and get_coefs 640, that a deep learning operator can implement in order to participate in backpropagation in a scikit-learn style pipeline. As described above in reference to FIG. 1, a deep learning operator can implement either transform or predict_proba 610, depending on whether the deep learning operator is a featurizer or a head respectively. As described above in reference to FIGS. 4 and 5, the deep learning operator can use transform or predict_proba 610 as part of a forward pass. The deep learning operator can use method backward 620 to calculate gradients at their inputs and learned coefficients as part of a backwards pass. The deep learning operator can use methods set_coefs 630 and get_coefs 640 to get the learned coefficients and to implement gradient descent in order to update learned coefficient values.

Diagram 600 additionally comprises an example implementation 680 of methods transform 610, backward 620, set_coefs 630, and get_coefs 640 in Dense with ReLU. Definition 682 represents an implementation of method transform 610. Definition 684 represents an implementation of method backward 620. Definition 686 represents an implementation of method set_coefs 630 and definition 688 represents an implementation of method get_coefs 640. It should be appreciated that more sophisticated neural networks, such as a multi-layer convolutional neural network or Transformer can be implemented using deep learning operators, as long as the deep learning operators can implement the four methods discussed in detail above.

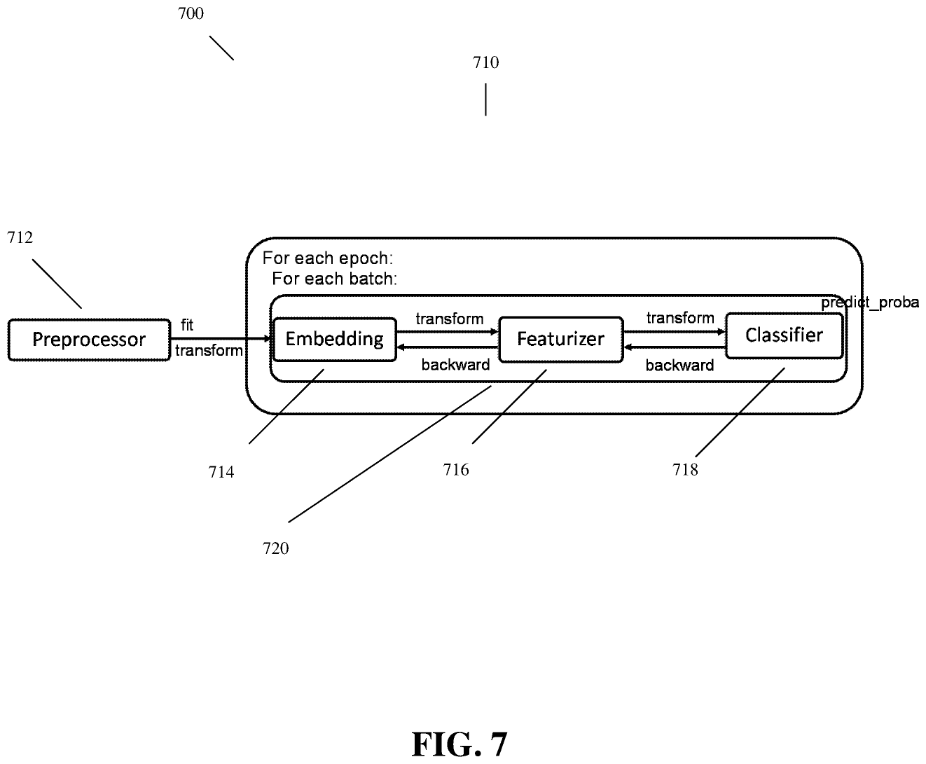

FIG. 7 illustrates an example, non-limiting diagram that can facilitate marking of deep learning operators by a higher order operator in accordance with one or more embodiments described herein. Repetitive description of like elements and/or processes employed in respective embodiments is omitted for sake of brevity.

Diagram 700 comprises a subset of deep learning and non-deep learning operators 710 represented as a scikit-learn style pipeline. Subset 710 comprises non-deep learning operator Preprocessor 712, and deep learning operators Embedding 714, Featurizer 716, and Classifier 718. As described above in reference to FIG. 1, deep learning operators in subset 710 can be marked by a higher order operator. Here, deep learning operators Embedding 714, Featurizer 716, and Classifier 718 are marked by higher order operator DeepNet 720, represented as the box containing Embedding 714, Featurizer 716, and Classifier 718. Subset 710 can be represented by the following code in a scikit-learn style pipeline:

pipeline=(preprocessor»DeepNet(operator=embedding»featurizer»classifier head)).

In this example, the pipe combinator ‘»’ chains operators together in the scikit-learn style pipeline and is equivalent to the make pipeline function in scikit-learn. DeepNet is itself an operator, because it can participate in a larger scikit-learn style pipeline. Specifically, in this example, the outer pipeline is made up of Preprocessor 712 and DeepNet 720. At the same time, DeepNet 720 is a higher order operator, because it takes a pipeline of other operators as an argument. In this example, the inner pipeline is made up of Embedding 714, Featurizer 716, and Classifier 718. As the inner pipeline comprises deep learning operators with the requisite methods for backpropagation, then DeepNet's 720 own fit method can be implemented by looping over epochs and batches, and performing forward passes, backwards passes, and descent gradient optimization as discussed in detail in reference to FIGS. 1, 4, and 5.

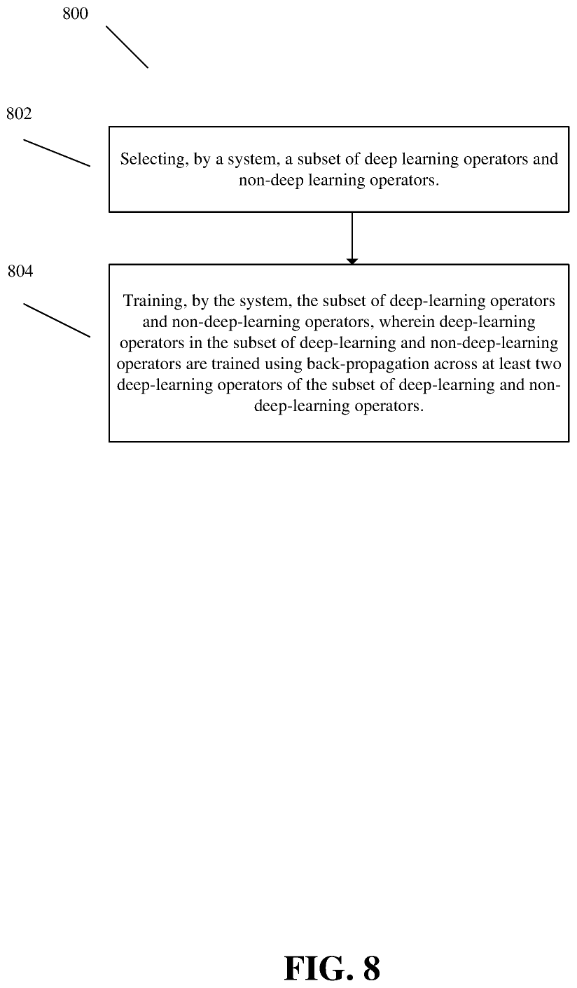

FIG. 8 illustrates a flow diagram of an example, non-limiting computer-implemented method 800 that can facilitate inter-operator backpropagation in AutoML frameworks in accordance with one or more embodiments described herein. Repetitive description of like elements and/or processes employed in respective embodiments is omitted for sake of brevity.

At 802, computer-implemented method 800 can comprise selecting, by a system (e.g., inter-operator system 101 and/or selection component 104) operatively coupled to a processor (e.g., processor 103), a subset of deep learning operators and non-deep learning operators. For example, as described above with reference to FIG. 1, selection component 104 can select a subset of deep learning operators and non-deep learning operators that is equivalent to a scikit-learn style pipeline of operators.

At 804, computer-implemented method 800 can comprise training, by the system (e.g., inter-operator system 101 and/or training component 105), the subset of deep learning operators and non-deep learning operators, wherein deep learning operators in the subset of deep learning and non-deep learning operators are trained using backpropagation across at least two deep learning operators of the subset of deep learning and non-deep learning operators.

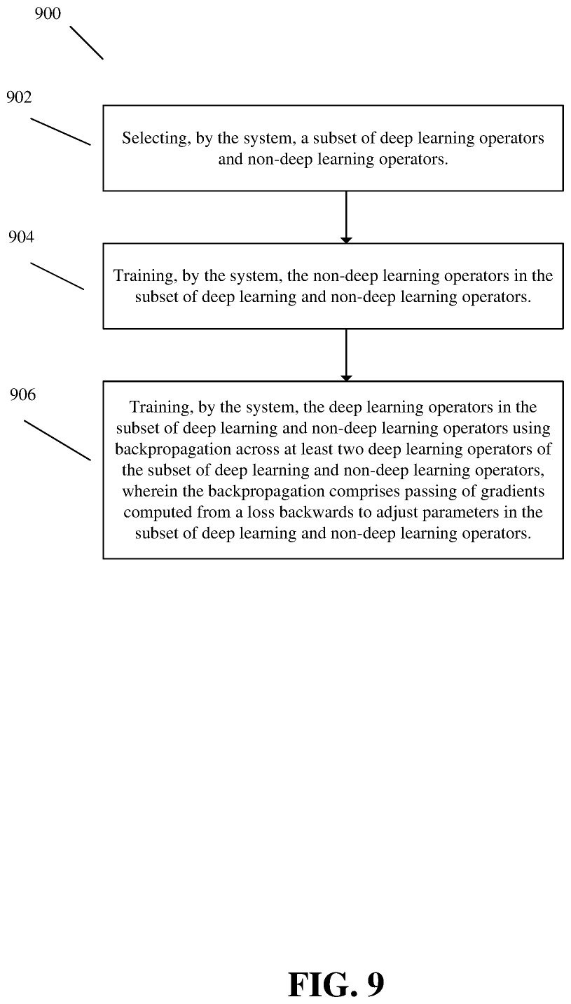

FIG. 9 illustrates a flow diagram of an example, non-limiting computer-implemented method 900 that can facilitate inter-operator backpropagation in AutoML frameworks in accordance with one or more embodiments described herein. Repetitive description of like elements and/or processes employed in respective embodiments is omitted for sake of brevity.

At 902, computer-implemented method 900 can comprise selecting, by a system (e.g., inter-operator system 101 and/or selection component 104) operatively coupled to a processor (e.g., processor 103), a subset of deep learning operators and non-deep learning operators.

At 904, computer-implemented method 900 can comprise training, by the system (e.g., inter-operator system 101 and/or training component 105), the non-deep learning operators in the subset of deep learning and non-deep learning operators. For example, as described above with reference to FIG. 1, training component 105 can use existing scikit-learn training methods in order to train non-deep learning operators.

At 906, computer-implemented method 900 can comprise training, by the system (e.g., inter-operator system 101 and/or training component 105), the deep learning operators in the subset of deep learning and non-deep learning operators using backpropagation across at least two deep learning operators of the subset of deep learning and non-deep learning operators, wherein the backpropagation comprises passing of gradients computed from a loss backwards to adjust learned coefficients in the subset of deep learning and non-deep learning operators. For example, as described above with reference to FIG. 1, training component 105 can use a training process comprising a forward pass, a backwards pass, and updating learned coefficients of the deep learning operators using an SGD optimizer. Additionally, as described above with reference to FIG. 1, training component 105 can iterate through the forward pass, backwards pass, and updating learned coefficients multiple times in order to improve training accuracy.

Inter-operator system 101 can be associated with various technologies. For example, inter-operator system 101 can be associated with automated machine learning, neural networks, scikit-learn style pipelines and/or other technologies.

Inter-operator system 101 can provide technical improvements to system, devices, components, operational steps, and/or processing steps associated with the various technologies identified above. For example, inter-operator system 101 can select a subset of deep learning and non-deep learning operators in a scikit-learn style AutoML pipeline and train both deep learning and non-deep learning operators in the subset. In the above examples, it should be appreciated that inter-operator system 101 can reduce resource usage and/or time involved in AutoML by selecting subsets comprising both deep learning and non-deep learning operators, as opposed to using different subset for deep learning operators and non-deep learning operators.

In another example, inter-operator system 101 can represent multi-layered neural networks as a series of multiple deep learning operators in a scikit-learn style pipeline. In the above example, it should be appreciated that inter-operator system 101 can reduce resource usage and/or time involved in AutoML training by using previously trained deep learning operators in multiple subsets of deep learning operators within the represented multi-layered neural network.

Inter-operator system 101 can provide technical improvements to a processing unit associated with inter-operator system 101. For example, in selecting a subset of deep learning and non-deep learning operators, inter-operator system 101 can handle both deep learning and non-deep learning operators without implementing separate subsets for deep learning and non-deep learning operators, thereby reducing the workload of a processing unit (e.g., processor 103) that is employed to execute the routines (e.g., instructions and/or processing threads) of AutoML. In this example, by reducing the workload of such a processing unit (e.g., processor 103), inter-operator system 101 can thereby facilitate improved performance, improved efficiency, and/or reduced computational cost associated with such a processing unit.

In another example, by representing neural networks as multiple deep learning operators in a scikit-learn style pipeline, inter-operator system 101 can pre-train coefficients of deep learning operators and then reuse the trained deep learning operators in different pipelines, thereby reducing the workload of a processing unit (e.g., processor 103) that is employed to execute the routines (e.g., instructions and/or processing threads) of training in AutoML.

A practical application of inter-operator system 101 is that it allows for AutoML frameworks that can accept both deep learning and non-deep learning operators. For example, a practical application of inter-operator system 101 is that it can be implemented to utilized non-deep learning operators for problems that are more effectively handled by non-deep learning and to utilize deep learning operators for problems that are more effectively handled by deep learning.

Inter-operator system 101 can employ hardware or software to solve problems that are highly technical in nature, that are abstract and that cannot be performed as a set of mental acts by a human. In some embodiments, one or more of the processes described herein can be performed by one or more specialized computers (e.g., a specialized processing unit, a specialized classical computer, a specialized quantum computer, and/or another type of specialized computer) to execute defined tasks related to the various technologies identified above. Inter-operator system 101 and/or components thereof, can be employed to solve new problems that arise through advancements in technologies mentioned above, employment of quantum computing systems, cloud computing systems, computer architecture, and/or another technology.

It is to be appreciated that inter-operator system 101 can utilize various combinations of electrical components, mechanical components, and circuitry that cannot be replicated in the mind of a human or performed by a human, as the various operations that can be executed by inter-operator system 101 and/or components thereof as described herein are operations that are greater than the capability of a human mind. For instance, the amount of data processed, the speed of processing such data, or the types of data processed by inter-operator system 101 over a certain period of time can be greater, faster, or different than the amount, speed, or data type that can be processed by a human mind over the same period of time.

According to several embodiments, inter-operator system 101 can also be fully operational towards performing one or more other functions (e.g., fully powered on, fully executed, and/or another function) while also performing the various operations described herein. It should be appreciated that such simultaneous multi-operational execution is beyond the capability of a human mind. It should also be appreciated that inter-operator system 101 can include information that is impossible to obtain manually by an entity, such as a human user. For example, the type, amount, and/or variety of information included in inter-operator system 101, selection component 104, and/or training component 105 can be more complex than information obtained manually by an entity, such as a human user.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 824, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036.

Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 846 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, and/or another wire and/or wireless communication network. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, and/or other program modules that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a selection component that selects a subset of deep learning operators and non-deep learning operators; and
a training component that trains the subset of deep learning operators and non-deep learning operators, wherein deep learning operators in the subset of deep learning and non-deep learning operators are trained using backpropagation across at least two deep learning operators of the subset of deep learning and non-deep learning operators.

2. The system of claim 1, wherein the subset of deep learning and non-deep learning operators is selected from a directed acyclic graph comprising deep learning operators and non-deep learning operators.

3. The system of claim 1, wherein the deep learning operators in the subset of deep learning operators and non-deep learning operators are marked by a higher order operator.

4. The system of claim 1, wherein the backpropagation comprises passing of gradients computed from a loss backwards to adjust learned coefficients in the subset of deep learning and non-deep learning operators.

5. The system of claim 1, wherein the subset of deep learning and non-deep learning operators is a specific instantiation of deep learning and non-deep learning operators and hyperparameters, wherein the hyperparameters are tuned automatically.

6. The system of claim 1, wherein the deep learning operators in the subset of deep learning and non-deep learning operators are implemented in different deep learning frameworks.

7. The system of claim 1, wherein the deep learning operators in the subset of deep learning and non-deep learning operators are implemented in a same deep learning framework.

8. A computer-implemented method, comprising:
selecting, by a system operatively coupled to a processor, a subset of deep learning operators and non-deep learning operators; and
training, by the system, the subset of deep learning operators and non-deep learning operators, wherein deep learning operators in the subset of deep learning and non-deep learning operators are trained using backpropagation across at least two deep learning operators of the subset of deep learning and non-deep learning operators.

9. The computer-implemented method of claim 8, wherein the subset of deep learning operators and non-deep learning operators is selected from a directed acyclic graph comprising deep learning operators and non-deep learning operators.

10. The computer-implemented method of claim 8, wherein the deep learning operators in the subset of deep learning operators and non-deep learning operators are marked by a higher order operator.

11. The computer-implemented method of claim 8, wherein the backpropagation comprises passing of gradients computed from a loss backwards to adjust learned coefficients in the subset of deep learning and non-deep learning operators.

12. The computer-implemented method of claim 8, wherein the subset of deep learning and non-deep learning operators is a specific instantiation of deep learning and non-deep learning operators and hyperparameters, wherein the hyperparameters are tuned automatically.

13. The computer-implemented method of claim 8, wherein the deep learning operators in the subset of deep learning and non-deep learning operators are implemented in different deep learning frameworks.

14. The computer-implemented method of claim 8, wherein the deep learning operators in the subset of deep learning and non-deep learning operators are implemented in a same deep learning framework.

15. A computer program product, the computer program product comprising one or more computer readable storage medium having program instructions embodied therewith, the program instructions executable by a processor to cause the processor to:
select, by the processor, a subset of deep learning operators and non-deep learning operators; and
train, by the processor, the subset of deep learning operators and non-deep learning operators, wherein deep learning operators in the subset of deep learning and non-deep learning operators are trained using backpropagation across at least two deep learning operators of the subset of deep learning and non-deep learning operators.

16. The computer program product of claim 15, wherein the subset of deep learning operators and non-deep learning operators is selected from a directed acyclic graph comprising deep learning operators and non-deep learning operators.

17. The computer program product of claim 15, wherein the deep learning operators in the subset of deep learning operators and non-deep learning operators are marked by a higher order operator.

18. The computer program product of claim 15, wherein the backpropagation comprises passing of gradients computed from a loss backwards to adjust learned coefficients in the subset of deep learning and non-deep learning operators.

19. The computer program product of claim 15, wherein the subset of deep learning and non-deep learning operators is a specific instantiation of deep learning and non-deep learning operators and hyperparameters, wherein the hyperparameters are tuned automatically.

20. The computer program product of claim 15, wherein the deep learning operators in the subset of deep learning and non-deep learning operators are implemented in different deep learning frameworks.
